(19) United States
(12) Patent Application Publication
(10) Pub. No.: US 2002/0046903 A1
(43) Pub. Date: Apr. 25, 2002

(54) Sport climbing structure

(76) Inventor: James Hamilton Strickler, Los Angeles, NY (US)

Correspondence Address: James H. Strickler, 144 North Sunset Drive, Ithaca, NY, 14850, US

(21) Appl. No.: 09/972,566

(22) Filed: Oct. 5, 2001

Related U.S. Application Data
(60) Provisional application No. 60/242,929, filed on Oct. 25, 2000.

(51) Int. Cl. A62B 1/16

(52) U.S. Cl. 182/36; 182/3

(57) ABSTRACT

An improved sport climbing wall is disclosed where the climber's path up and down the wall is restricted to a well defined zone via a tether connecting the climber's harness to a trolley which is, in turn, guided along a track located behind the surface of the wall. This guide serves to control the motion of the climber so as to allow architectural improvements in the design of climbing gymnasiums while enhancing the safety of the climber. Specifically, the guide track makes it possible to build walls at steeper angles, and to provide viewing galleries in greater proximity to the climber than was heretofore safely possible using existing methods of descent control. The improved climbing wall also enhances the safety of the climber by reducing the extent of swinging and falling common to conventional climbing wall rope control methods.

### BACKGROUND OF THE INVENTION

This invention relates to sport climbing and the structures and safety systems provided therefore. The present inventor has invented sport climbing systems as described in U.S. Pat. No. 5,732,954, and which, providing background relating to the present invention, is hereby incorporated by reference. The present inventor has further innovated automated safety systems for sport climbing that were disclosed in U.S. patent application Ser. No. 08/166045 now abandoned. This application provides further background relating to the present invention and is hereby also incorporated by reference.

The present invention is related more specifically to a steep overhanging sport climbing wall with a novel track and trolley means for guided ascent and descent embedded therein. This improved climbing wall allows a climber to ascend with continuous overhead rope protection from falling and to descend in a controlled manner along a guided path.

Numerous types of climbing structures have been developed over recent decades having a variety of structures and compositions. The following patents may be relevant to the present invention, and the full disclosure of each is incorporated herein by reference: U.S. Pat. Nos. 4,941,548, 4,997,064, 5,092,587; 5,125,877; 5,254,058; 5,256,116; 5,543,185; 5,593,368 and 6,083,142.

Belaying: Because of the prospect of injury from falling, the sport climber is usually protected by a rope tied to a seat or chest harness. As the climber ascends the climbing wall the rope is controlled through a process referred to as belaying, either by a person or a machine (the belayer). In this process rope is fed out or pulled in by the belayer as desired by the climber, but is held static upon the climber falling so as to arrest their descent before he or she can hit the ground. There are two distinct styles or modes of climbing (and belaying): top-roping and lead climbing. As set forth in greater detail below, climbing walls are distinctly configured to accommodate each of these processes. As further detailed below, the climbing wall of the present invention is configured with a novel addition of a track and trolley apparatus that provides the advantages of each belaying mode.

Top Roping: In the top-roping mode the safety rope is generally strung from the climber's harness directly to a turning point at the top of the wall from whence it passes to the belayer. As the climber ascends, the rope is taken in so that only a small amount of slack is present. Should the climber fall off the wall, the fall is thus arrested after a very short distance as soon as the rope goes taught. Top-roping provides a high degree of safety on walls wherein the route of the climber follows the plumb of the rope. In cases, however, where the wall is significantly overhanging, or where the climber's route traverses to the side of the line of plumb, the climber is exposed to dangerous swings upon falling. These swings can result in injury both to the climber and also to persons on the ground or to climbers on adjacent parts of the wall.

Leading: In the lead climbing mode, the climber's rope passes from their harness through a series of protection anchors distributed along their path or route downward to the belayer As the climber ascends he or she passes the rope through successively higher protection points. The nature of lead climbing exposes the climber to falls of greater length than those of top-roped climbing, since the climber may fall up to twice the distance between protection points plus the incremental slack in the line. This may result in injury to the climber at times.

### BRIEF SUMMARY OF THE INVENTION

The present invention consists of an improved form of recreational climbing structure wherein the path of the climber up and down the wall is constrained by a track, trolley and tether apparatus. As will be explained in greater detail with respect to detailed drawings below, the climber is attached to the structure by means of a tether and trolley, which are free to move up the wall along a curvilinear path as defined by a track located behind the surface of the structure. The trolley is held in a position generally above the climber by means of a belayed rope that runs through the track up to the top of the structure. This novel arrangement restricts the path of the climber up the wall to a narrow path (approximately twice the length of the tether) and further serves to guide his/her descent, limiting undesirable swings or excessive falls.

### OBJECTS OF THE INVENTION

It is an object of the invention to allow inexperienced climbers to comfortably climb steep walls. Most beginners are uncomfortable lead climbing because of the difficulty of clipping protection, because of the perceived risk of injury, and because of innate fear. It is an object of the apparatus disclosed herein allows beginning climbers to ascend steep walls while under continuous overhead protection.

It is a further object of the invention to prevent swings and injuries. When a top-roped climber, who has ascended a route that departs from the plumb of the rope, falls they will generally swing as a pendulum. These swings can result in injuries in instances where climbers collide with other climbers, with belayers on the floor of the gym, or with other parts of the wall. Thus it is an object of the present invention to limit the swing of falling climbers in order to prevent human injury.

It is a further object of the invention to prevent climbers from lowering onto others. When top-roped climbers are lowered to the ground beneath overhanging walls they frequently land amidst crowds of people, both belayers and people waiting to climb, who are gathered on the floor beneath the climbing walls. This creates not only a great annoyance to the climbers and the people beneath, but occasional injuries as persons are kicked in their heads. Thus it is an object of the current invention to constrain the landing of top-roped climbers to a vacant zone at the base of the wall.

It is a further object of the invention to economize the space utilization of climbing gyms. In order to prevent the above dangers of injury due to swings and lowering some climbing gyms have been designed with clear floor areas that are intended to be landing and swing zones. These areas are kept free of bystanders. However, the occupancy cost of the footprint of an urban facility is often its greatest operational expense so that these swing zones can significantly impair the financial viability of the facility. It is thus an object of the current invention to reduce the size of the swing zone so that the facility may make more efficient use of its footprint.

It is a further object of the invention to provide for more proximal viewing of climbing. It is desired in many climbing facilities to provide mezzanines or viewing areas for observers to watch people as they climb. However, in current facilities these viewing areas are constrained as to their proximity to the climbing wall by the need to maintain a clear swing and lowering zone for falling climbers. Thus it is an object of the current invention to constrain the swing and lowering path of falling climbers to a zone close to the climbing wall in order to allow for more proximal viewing areas.

It is a further object of the invention to allow steeper overhangs in reduced clearing height climbing facilities: Reduced clearing height facilities are presently only able to provide a limited horizontal travel for roped climbers because of the combined effects of rope slack and rope stretch. The steepest safe angle for a climbing wall is usually no greater than 45 degrees overhanging. Beyond this there is too great a risk that the combined effects of slack in the lead rope and rope stretch would allow a climber to fall close enough to the floor to clobber a bystander with their feet. It is an object of the present invention to reduce the slack in the belay system thereby allowing much steeper walls.

### BRIEF DESCRIPTION OF THE SEVERAL VIEWS OF THE DRAWINGS

For a fuller understanding of the nature and objects of the invention, reference should be made to the following detailed description and the accompanying drawings, in which.

FIG. 1 is a diagrammatic view of a climbing gym showing a profile of a top-roped climbing wall construction, which is improved upon by the present invention FIG. 2 is a diagrammatic view of a climbing gym showing a profile of a lead climbing wall construction, which is improved upon by the present invention.

FIG. 3 is a diagrammatic view of a climbing gym showing a profile view of a pair of guided descent climbing walls—two embodiments of the present invention.

FIG. 4 is a diagrammatic view of a climbing gym design illustrating the application of the present invention to achieve improved observation mezzanines, an important benefit of the present invention.

FIG. 5 is a diagrammatic view of a climbing gym design illustrating a hyper-steep climbing wall and a viewing grandstand made safe by the present invention.

FIGS. 6A, 6B & 6C provide diagrammatic views of a preferred embodiment of the current invention showing the track and trolley construction from the front, as well as longitudinal and transverse cross sections respectively.

### DETAILED DESCRIPTION OF THE DRAWINGS

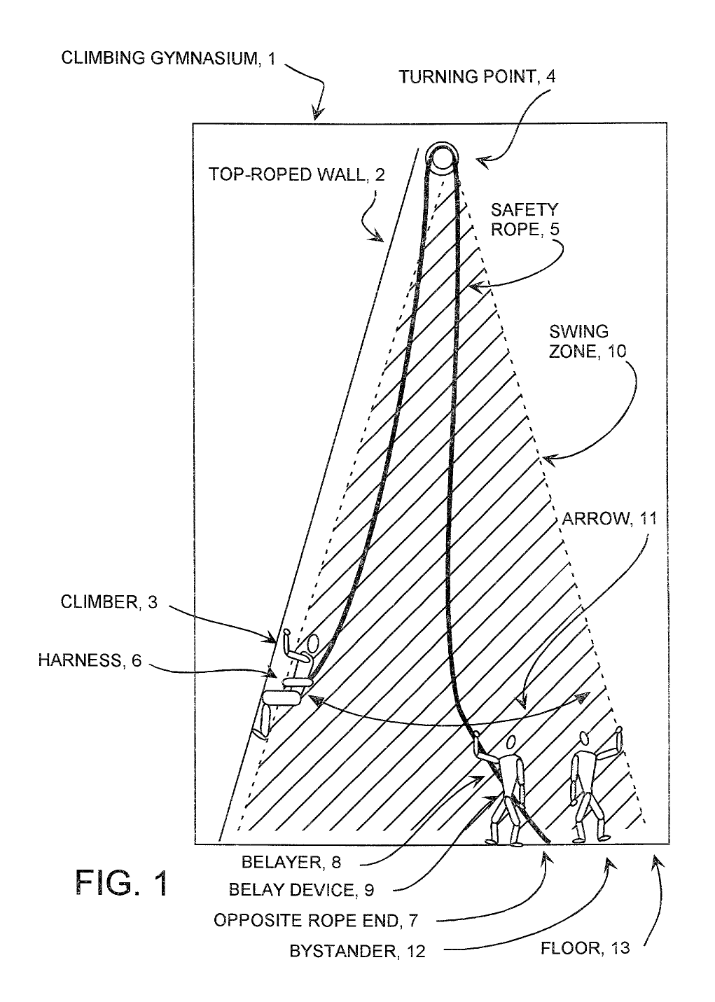

FIG. 1 is a diagrammatic view of a climbing gymnasium, 1, illustrating a top-roped wall, 2, one of two current common climbing wall constructions improved upon by the present invention.

The top-roped wall, 2, provides the climber, 3, with a turning point, 4, about which is passed a safety rope, 5 one or more times. This rope, 5, is most commonly attached to the climber, 3, by means of a harness, 6, to which it is tied. The opposite end, 7, of the rope, 5 is most commonly controlled by a person, 8, referred to as a belayer, using any of a variety of well know manually operated belay devices, 9, such as the Gri-Gri, the stitch plate or the figure eight. Should the climber, 3, fall during his or her ascent of the wall, 2, he/she generally will swing in a zone, 10, as indicated by arrow, 11. This can create a safety hazard not only to the climber, 3, and the belayer, 8, but also to any nearby climbers, (not shown) on adjacent areas of the wall, 2, as well as to any bystander, 12, on the floor 13.

The energy with which a climber, 3, will swing upon falling generally increases with the degree of steepness of the wall, 2, so the top-roped climbing wall construction is therefore generally limited to walls near or less than vertical.

It should be noted that, upon falling, the climber, 3, will at times wish to resume climbing from the point at which he/she fell after resting in suspension on the rope, 5. However, as is readily apparent from this figure, for overhanging walls, it will often not be possible to resume climbing from the high point since the fallen climber will swing far enough from the wall, 2, that it is impossible to regain hold thereof.

FIG. 2 is a diagrammatic view of a climbing gymnasium, 1, illustrating a lead wall, 20, one of two current common climbing wall constructions improved upon by the present invention.

The lead wall, 20, provides the climber, 21, with a series of protection points, 22, which each generally includes a carabiner, 23, through which the climber successively passes the lead rope, 24, during his or her ascent. The “hot end”, 25, of the lead rope, 24, is again tied to a harness, 26, worn by the climber, 21. The opposite end, 28, of the rope, 24, is controlled by a belayer, 29, by means of a belay device, 30. Upon arriving at a successive protection point, 31, the climber, 21, will pull up a loop of slack, 32, which he/she will clip into the carabiner, 33 This construction of the lead wall, 20, can, at times, present considerable safety hazard to both the climber, 21, and the belayer, 29 For example, should the climber, 21, fall at the moment before clipping into the carabiner, 33. he/she will often travel a good distance as indicated by the arrow, 35, before stopping, and may hit the belayer, 29. Furthermore, at times the climber, 21, may forget to clip into one of the protection points, 22, exposing himself/herself to a great fall. Thus, the lead wall construction, 20, generally poses greater hazard to climbing participants, and requires greater skill and training than the top-roped wall.

It should be noted that while it is possible to construct the lead wall, 20, at steeper overall angles than the top-roped wall, 2, of FIG. 1 since the swing of the climber, 21 is limited by the protection points, 22, the maximum safe angle is still generally limited to less than 45-degrees past the vertical. Beyond that angle the combination of pre-fall rope slack, and post fall rope stretch may allow the climber, 21, to kick the belayer, 29, in the head

It should also be noted that since the climber, 21, may pass through any part of the descent zone, 34, upon descending, it is necessary to keep this zone clear of any structures.

As will be set forth more fully below, the present invention eliminates the hazards of substantial swing, which characterizes the top-roped wall, 2 of FIG. 1, and the hazard of substantial fall, which characterizes the lead-wall, 20 of FIG. 2.

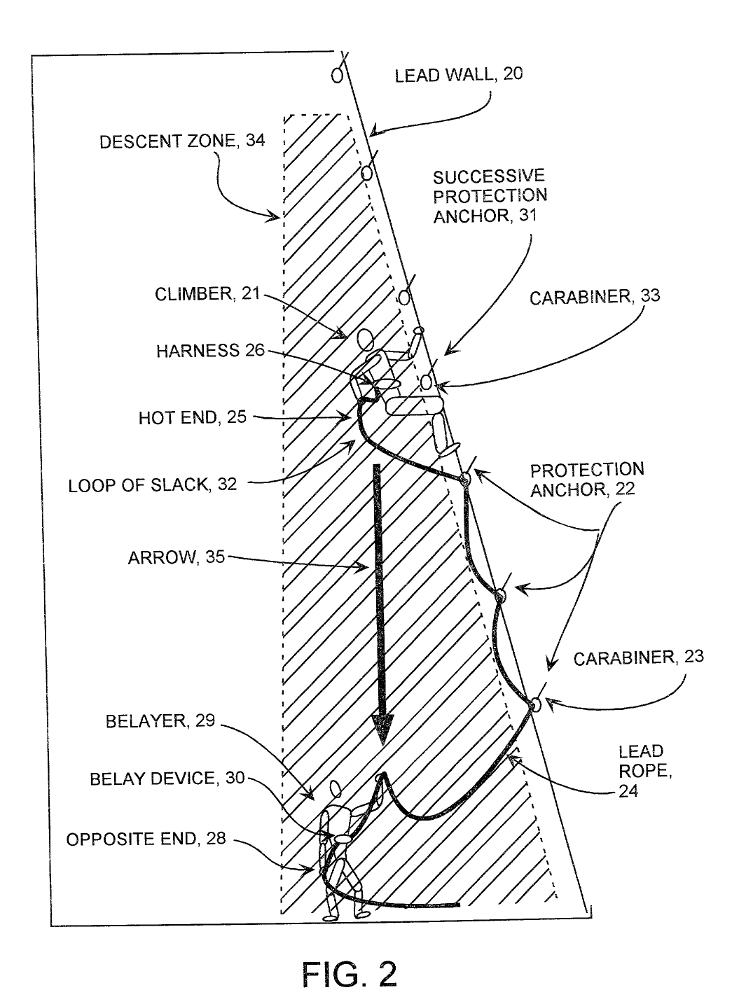

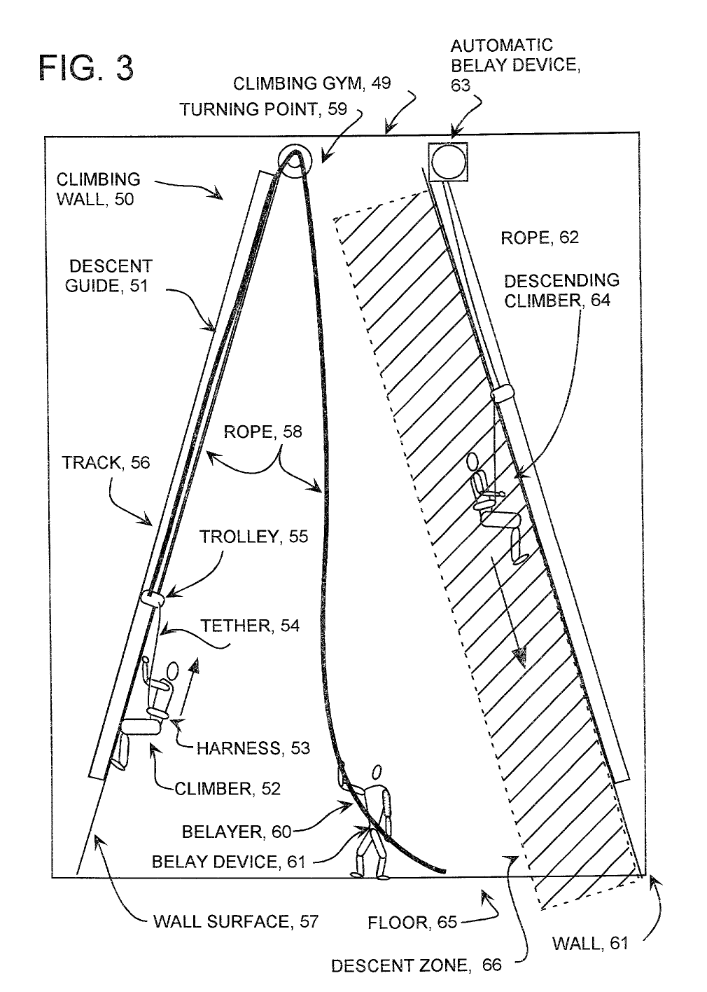

FIG. 3 illustrates a schematic diagram of a climbing gym design, 49, using the improved climbing wall, 50, of the present invention, which incorporates a descent guide, 51 With this wall, 50, the climber, 52, is attached by means of a harness, 53, and tether, 54, to a trolley, 55, which is guided up the wall, 50, by means of a track, 56, located behind its surface, 57. A rope, 58, attached to the trolley, 55, passes through the (or along) the track, 56, up to a turning point, 59, and down to a belayer, 60. As the climber, 50, ascends the climbing wall, 50, the belayer, 60, takes in the rope, 58, which may be controlled by aid of a belay device, 61 in the customary manner.

It is noted that the rope, 58, may be wrapped one or more times around the turning point, 59, in order to increase the frictional resistance between them.

It is noted that the components of the descent control system, 51, specifically, the track, 56, the trolley, 55, and the tether, 54 may be constructed of a variety of materials and may be arranged in a variety of specific configurations while not deviating from the specific concept of this invention. For example, the track, 56, may be comprised of a metal, glass, or plastic extrusion or rolled form having a variety of cross sectional profiles such as a channel, a t form, an I form, or many other variations upon these. The trolley, 55, may be formed of metal or plastic and may have a set of wheels to provide for reduced friction as it moves up and down the track, 56. Alternately it may have a sliding form with bearing surfaces designed to simply slide along a set of complimentary surfaces of the track, 56. The tether, 54, may be composed of a simple piece of nylon or metal wire rope, or may be formed of a more elastic material such as bungee cord sleeved by a nylon jacket.

Alternately, as shown for the wall, 61, of the right side of the drawing, control of the rope, 62, may be provided using an automatic belay device, 63, which substitutes for the belayer, 60, and the turning point, 59. Examples of such automatic belay devices are described more thoroughly by the inventor in U.S. patent application Ser. No. 08/166045, now abandoned.

Regardless of the means of control of the rope, 58, the path taken by a fallen climber 64, as he/she is lowered to the floor, 65, following a fall or completion of an ascent is constrained to a zone, 66, close to the wall, 61. This represents a significant improvement in descent control over both the case of the top-roped wall, 2, of FIG. 1, where the climber was free to swing though a wide zone, 13, and the case of the lead wall, 20, of FIG. 2 where the climber, 21, fell straight down. In the case of the present invention, the climber is both protected from any extended fall, as characterizes the lead wall, 20, of FIG. 2 and from the exaggerated swing which characterizes the top-roped wall, 2, of FIG. 1. Thus, this track and trolley system offers significantly greater safety and descent control than climbing walls of prior art, and is a substantial improvement thereupon.

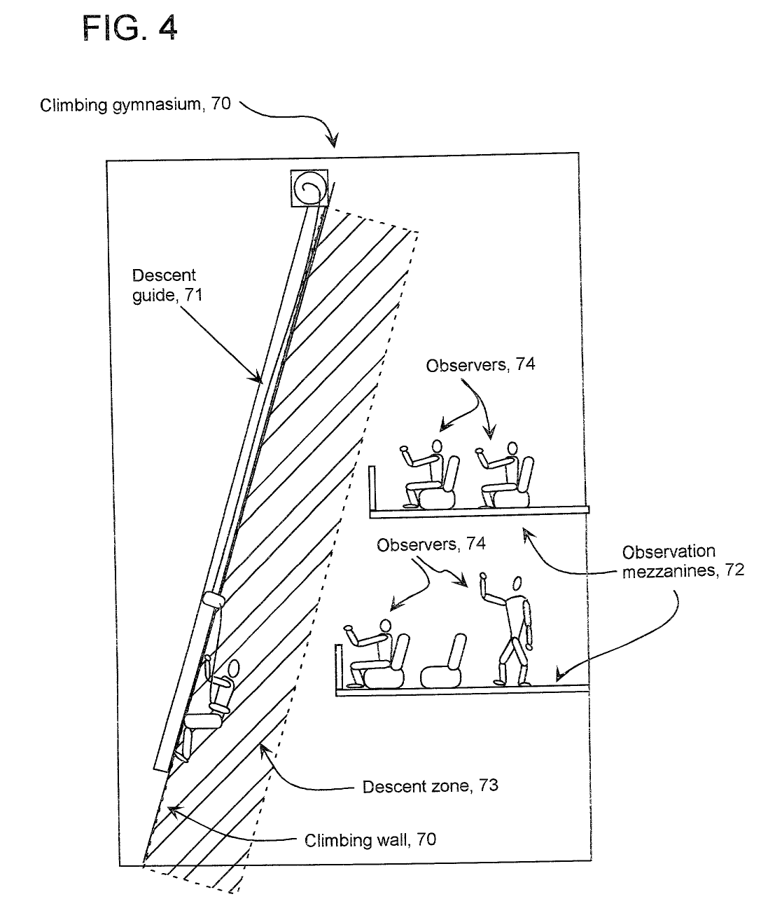

FIG. 4 illustrates a schematic diagram of an improved climbing gym architecture made possible by incorporating climbing walls, 70, of the present invention which include the descent guide, 71 as described above with respect to FIG. 3. FIG. 4 specifically illustrates the inclusion of observation mezzanines, 72, in much greater proximity to the climbing walls, 70, than was heretofore possible with the existing top-roped wall, 3, of FIG. 1 or the lead wall, 21, of FIG. 2. These mezzanines, 72, which may be positioned just outside of the descent zones, 73, provided by the safety track systems, 71, offer observers, 74 much better opportunity for viewing competitive climbing events than existing gyms. These events are anticipated to increase the popularity of sport climbing in general and of facilities that host such events in particular For the case of the top-roped wall, 2, of FIG. 1, where the climber was free to swing though a wide zone, 13, and the case of the lead wall, 20, of FIG. 2 where the climber, 21, fell straight down, observation mezzanines would need be positioned further from the walls in order to prevent falling climbers from colliding with them and sustaining injuries. Thus, the climbing wall of the present invention offers a second significant advantage over climbing walls of prior art.

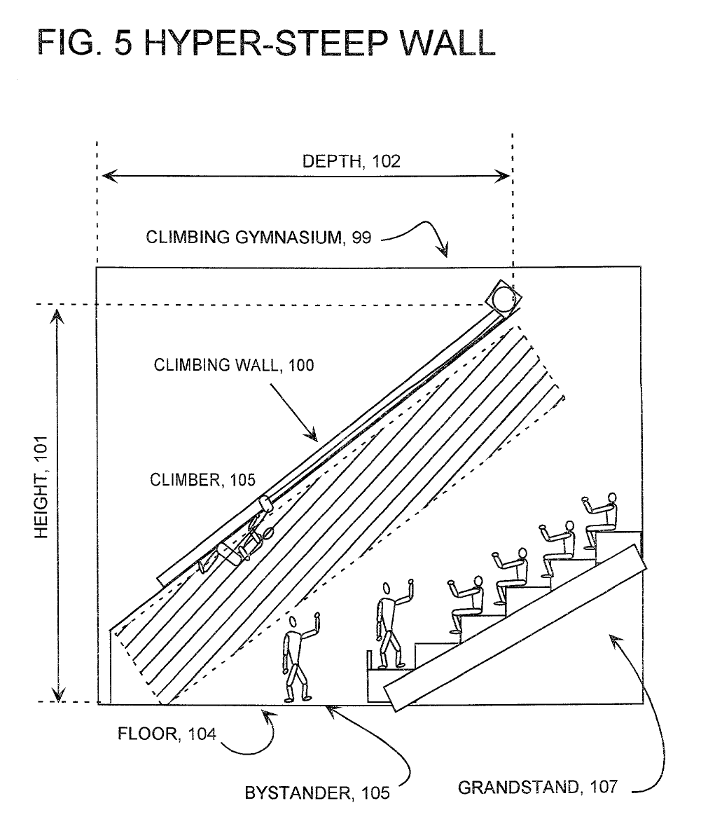

FIG. 5 illustrates a schematic diagram of a climbing gymnasium, 99, incorporating a climbing wall, 100, of the present invention having a height, 101, to depth, 102, aspect ratio greater than unity. Such a hyper-steep wall, 100, would not be possible to construct in a safe manner using the top-roped and lead wall constructions of prior art since the climber, 103, would be exposed to a fall in which he/she might hit the floor, 104, or a bystander, 105.

Such hyper-steep walls are very desirable for competitive events since they provide a severely difficult climbing terrain without the need for building high clearing height. Such difficulty is necessary to provide sufficient challenge to highly skilled competitors. Furthermore, these walls provide excellent viewing opportunity for observers who may be positioned on a grandstand, 107, as shown, without the need for the mezzanine structures of FIG. 4.

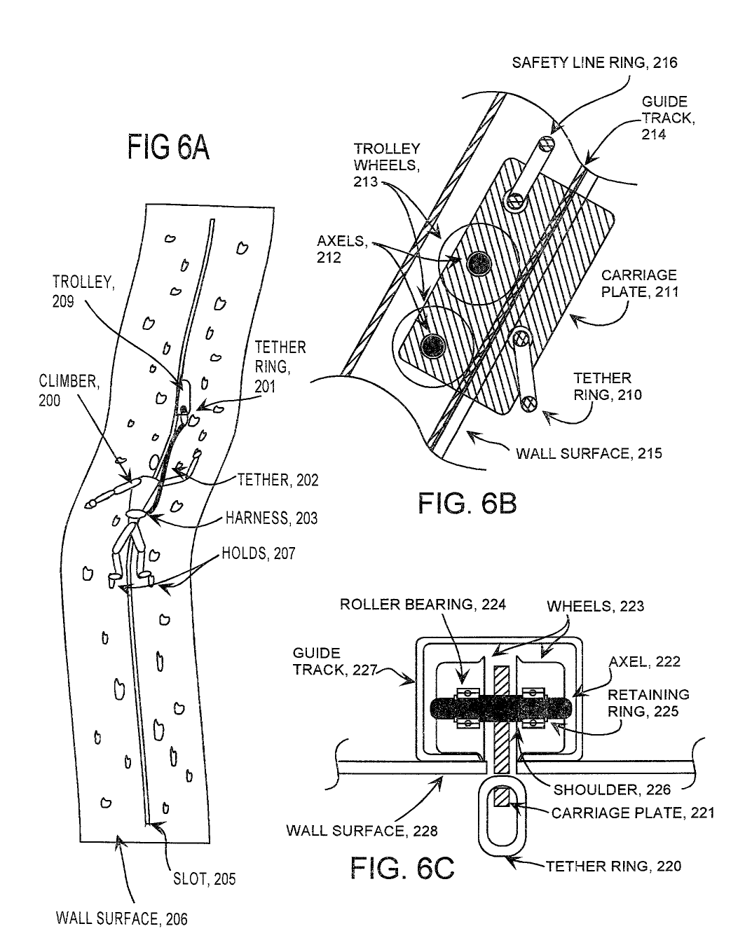

FIG. 6A illustrates a schematic diagram of the frontal view of an embodiment of the invention The climber, 200, is attached to a tether ring, 201, by means of a tether, 202, and a harness, 203. The ring, 201, is linked to the carriage of a trolley, 204, protruding from a slot, 205, that divides the surface of the wall, 206 As the climber ascends by means of holds, 207, the trolley, 204, is drawn upward, by means of a rope that is hidden behind the wall surface, 206, so as to remain above the climber, 200. Should the climber, 200, fall during his/her ascent, the fall will be arrested by the rope hidden behind the wall surface, 206, and he or she will be held close to the surface of the wall, 206, by the tether, 202. In the preferred embodiment of the invention, the slot, 205, is narrow so that the climber may not jam his of her fingers in it.

FIG. 6B illustrates a schematic diagram of a longitudinal cross sectional view of an embodiment of the invention wherein the tether ring, 210, is linked to a carriage plate, 211, which is penetrated by a pair of axels, 212, (coming out of the page). The axels, 212, in turn support a set of trolley wheels, 213, which roll along the inner surface of a guide track, 214, so as to transport and constrain the movement of the tether ring up and down the slot, 205, of FIG. 6A. The trolley wheels, 213, lie in front of and behind the plane of the carriage plate, 211, and are thus a pair of pairs—only one of which is shown. As may be most easily understood with reference to FIGS. 3, 4, 5 and 6A the guide track, 214, lies behind the wall surface, 215, with respect to the tether ring, 210. As may be more easily understood when viewed in combination with FIG. 3, the safety line ring, 216, provides a means for raising the trolley, 55, up the guide track, 56, of that drawing in response to the ascending movements of the climber, 52.

FIG. 6C illustrates a schematic diagram of a transverse cross sectional view of a portion of the wall surface, 206, and hidden guide track and trolley of FIG. 6A. The tether ring, 220, is shown linked to the carriage plate, 221, which lies in the plane perpendicular to the drawing. The axel, 222, which penetrates through, and is welded to the carriage plate, 221, supports a pair of wheels, 223, by means of a pair of roller bearings, 224. The bearings, 224, are held in position on the axel, 222, by means of a pair of retaining rings, 225, and a pair of shoulders, 226. The trolley assembly, 208, comprising the carriage plate, 221 and associated components is contained within the channel of a guide track, 227, which is located behind the wall surface, 228, with only the tether ring, 220, and a portion of the carriage plate, 221, protruding through slot, 229. The trolley assembly, 208, is thus constrained to move in a lineal motion parallel to the axis of the guide track, 227, thereby guiding the motion of the tether ring, 220, and the motion of the climber, 200, of FIG. 6A.

It will thus be seen that the invention efficiently attains the objects set forth above, in particular it allows inexperienced climbers to comfortably climb steep walls; prevents swings and injuries; prevents climbers from lowering onto others; economizes the space utilization of climbing gyms; provides for more proximal viewing of climbing; and allows steeper overhangs in reduced clearing height climbing facilities.

It will be understood that changes may be made in the above construction and in the foregoing sequences of operation without departing from the scope of the invention. For example, the climbing tether may be tied directly around the waist of the climber without the use of a harness, or the climber may climb down the wall without releasing hold of the wall. Alternately, the rope may be attached directly to the climber, who is also tethered to the trolley to effect the same path of descent.

It is accordingly intended that all matter contained in the above description or shown in the accompanying drawings be interpreted as illustrative rather than in a limiting sense.

It is also to be understood that the following claims are intended to cover all the generic and specific features of the invention as described herein, and all statements of the scope of the invention which, as a matter of language, might be said to fall there between.

Having described the invention, what is claimed as new and secured by Letters Patent is:

1. A recreational climbing structure, means, comprising a climbing surface and a descent control apparatus,
said climbing structure including a first point at the base of said structure, and a second point higher on said structure;
said descent control apparatus including a guide track passing from said lower point to said higher point,
and further comprising a trolley carriage means, constrained to move on said guide track in a curvilinear path defined thereby,
a tether, means, attached to said trolley carriage by one of its two ends.

2. A recreational climbing structure, means, as in claim 1 wherein
said guide track is located behind said climbing surface,
said surface being divided by a slot which passes from said lower point to said higher point such that a portion of said trolley carriage protrudes through said slot, to which is attached said tether, means

3. A recreational climbing structure, means, as in claim 1, wherein said guide track is a metal extrusion.

4. A recreational climbing structure, means, as in claim 1, wherein said guide track is a formed metal channel.

5. An apparatus for providing a safe recreational climbing experience comprising a substantially overhanging climbing structure means, a guide track means, conforming to the surface of said structure means, a truck means guided by said guide track up and down its length, a turning axis located at a high point on said structure, a suspension element having one end attached to said truck, and passing therefrom to said turning axis at said high point on said structure.

6. An apparatus as in claim 5, wherein said suspension element passes from said turning element to a belay device.
